(19) United States
(12) Patent Application Publication
(10) Pub. No.: US 2015/0296358 A1
(43) Pub. Date: Oct. 15, 2015

(54) EVACUATION NOTIFICATION TERMINAL DEVICE AND EVACUATION NOTIFICATION SYSTEM

(71) Applicant: Ichiro AKUTSU, Saitama (JP)

(72) Inventor: Ichiro AKUTSU, Saitama (JP)

(21) Appl. No.: 14/676,440

(22) Filed: Apr. 1, 2015

(30) Foreign Application Priority Data
Apr. 14, 2014 (JP) 2014-082484

(51) Int. Cl. H04W 4/22; H04W 4/02

(52) U.S. Cl. CPC H04W 4/22; H04W 4/02

(57) ABSTRACT

The present invention provides an evacuation notification system that can provide notification of the number of evacuees taking shelter in multiple emergency evacuation facilities or apparatus, and allows evacuation conditions to be accurately ascertained on the basis of such notifications.

An evacuation notification system comprises an evacuation notification terminal device that is capable of automatically transmitting evacuation notification information including an inputted number of evacuees, a determined evacuation position, and identifying information at a predetermined time interval and is provided at an evacuation site, and a receiving terminal device in a disaster center that displays an evacuation position marker on a map displayed on a terminal screen and a number of evacuees associated with the marker on the basis of the number of evacuees, evacuation position, and identifying information included in the received evacuation notification information transmitted from the evacuation notification terminal device, and can display movement history.

### TECHNICAL FIELD

The present invention relates to an evacuation notification terminal device and an evacuation notification system that notifies an evacuation monitoring location (such as a disaster center set up by local authorities) of the number of evacuees at an evacuation site when a natural disaster such as a tsunami or flood occurs or when an evacuation warning is issued, allowing evacuation status to be swiftly and precisely ascertained.

### TECHNICAL BACKGROUND

Generally, strategies for combating water-related disasters such as tsunamis and floods have centered on local authorities. In the case of tsunamis, for example, massive breakwaters are built to prepare for the onset of tsunamis, or the authorities may instruct the populace to quickly evacuate to higher ground when a tsunami warning is issued.

However, breakwaters were broken by the unexpected massive tsunami produced by the 2011 Tohoku earthquake, failing to stop the onslaught of the tsunami and leading to numerous deaths. Individuals who evacuated to higher ground survived. It is clear from this that evacuating to higher ground is of utmost importance and a fundamental part of surviving a disaster. However, even when there are designated tsunami evacuation sites, these are often at higher ground in geographical terms, and it may take effort to reach these evacuation sites, which are not necessarily each to utilize. Wheelchair users, the elderly, children, and other socially disadvantaged individuals experience particular difficulties.

Thus, various types of tsunami evacuation facilities have been proposed that can be used without hesitation in emergencies, yield the same effects as evacuation to higher ground without having to actually climb to higher ground, and can be safely used by socially disadvantaged as described above. The Applicant has previously proposed an emergency evacuation apparatus (emergency evacuation shelter) (see patent document 1). The emergency evacuation apparatus has a configuration in which guide means that passes through a central space of a ring-shaped floating body comprising a watertight hollow chamber so that there is play therebetween is anchored to a platform upon which the ring-shaped floating body rests. The guide means is provided to reach higher than the water level of an expected tsunami or flood, and, when a tsunami or flood occurs, the ring-shaped floating body floats up from the platform and is guided up and down by the guide means as the water level rises and falls. As a result the ring-shaped floating body easily avoids the water pressure of water current and is not easily broken by water pressure, and, when the tsunami or flood has passed, the ring-shaped floating body returns to the location where it was resting on the platform.

In the proposed emergency evacuation apparatus, the height of the guide means is set according to the water level of an expected flood or tsunami; thus, if a tsunami or flood having a higher than expected water level occurs, the ring-shaped floating body will separate from the guide means, float on the water, and drift away. However, because the ring-shaped floating body stably floats even when drifting away, the safety of evacuees taking shelter in the ring-shaped floating body can be ensured.

Various disaster response support systems allowing evacuation conditions in the event of a disaster such as a tsunami or flood to be ascertained have also been proposed (see, for example patent documents 2-5); these systems allow evacuation conditions to be ascertained in terms of affected locations and numbers of evacuees.

### PRIOR ART DOCUMENTS

### Patent Documents

[Patent Document 1] Japanese Patent No. 5274699

[Patent document 2] Laid-open Japanese Patent Application No. 2012-105129

[Patent document 3] Laid-open Japanese Patent Application No. 2007-235325

[Patent document 4] Laid-open Japanese Patent Application No. 2003-323683

[Patent document 5] Laid-open Japanese Patent Application No. 2008-021029

### SUMMARY OF THE INVENTION

### Problems to be Solved by the Invention

As discussed above, various types of emergency evacuation facilities and apparatus capable of handling tsunamis and floods have been proposed. However, there is the problem that, even if a plurality of such emergency evacuation facilities and apparatus are made available, an evacuation monitoring location such as a disaster center set up by local authorities is incapable of instantaneously ascertaining the number of evacuees having evacuated to the facilities/apparatus at various evacuation sites when a disaster actually occurs. Thus, disaster centers are formed to take pains to ascertain evacuation conditions and end up relying on conflicting or uncertain information, increasing the amount of time necessary to organize rescue and support efforts. In addition, even if a disaster center issues an evacuation warning when a disaster is predicted, the disaster center is incapable of immediately obtaining information on the number of individuals having evacuated to the various facilities/apparatus, and needs time and effort to correctly ascertain evacuation conditions. Moreover, in the abovementioned proposed disaster response support system, it is difficult to ascertain the location and number of evacuees when evacuees change location.

In the disaster response system proposed in patent document 2, individual users in a group carry a plurality of portable terminals, and, when a disaster strikes, the users only acquire information for their current positions and send the positional information to a disaster response support server; the number of affected individuals is identified by a process performed on the disaster response support server. Thus, the disaster center is incapable of immediately ascertaining how many individuals have evacuated to an evacuation site, evacuation facility, evacuation shelter, or the like.

The communication terminal disclosed in patent document 3 is provided with information-for-transmission creation means for creating information for transmission on the basis of preset information (home address information, evacuation address information) and evacuee number information inputted using input means, a contact unit for contacting a power line, and a transmission unit for transmitting the information for transmission created by the information-for-transmission creation means via a power line when contact with the power line has been made. Because the evacuation address information is preset information, not positional information determined by the communication terminal, and the communication terminal is not provided with means for determining the current position, it is difficult to ascertain the current position of the communication terminal when the terminal itself changes location.

The disaster response system proposed in patent document 4 is provided with a map information database for storing map information for displaying a map, a disaster response information database for storing disaster information in association with the map, and a server for outputting a map to a web on the Internet, storing disaster information in the disaster response database in association with the map when an authorized user identifies a position on the map and inputs disaster information, displaying a corresponding icon on the map on the web, and displaying corresponding disaster information when the icon is selected. The disaster response information includes dangerous location information pointing out dangerous locations in a residential area and information regarding priority evacuees requiring priority in evacuation (priority evacuee information) for elderly and disabled individuals in a residential area that have been registered at the request of the individuals themselves or their families. However, it is impossible to immediately ascertain the number of individuals that have evacuated to an evacuation site, evacuation facility, or evacuation shelter, and, in particular, the number of evacuees and current position of an evacuation shelter that has been carried off.

The present invention was conceived in view of the problems described above, it being an object thereof to provide an evacuation notification terminal device and an evacuation notification system that can easily provide notification of the number of evacuees taking shelter in an emergency evacuation facility or an apparatus such as a evacuation shelter, and automatically transmits the current position thereof, allowing evacuation conditions to be accurately ascertained on the basis of the notification of the numbers of evacuees and current position thereof.

### Means for Solving the Problem

In order to achieve the object proposed above, the invention according to the present application comprises the following features.
(1) An evacuation notification terminal device of the evacuation notification system according to the present invention comprises: input means comprising at least numerical keys for inputting the number of evacuees having evacuated to a evacuation site; position-determining means that uses a global positioning system (GPS) to automatically determine evacuation position when the device is powered on; control means for creating evacuation notification information including the number of evacuees inputted by an evacuee, the determined evacuation position, and identifying information for the evacuation notification terminal device; and transmission means for automatically wirelessly transmitting the created evacuation notification information at a predetermined time interval when a transmit button is pressed after the number of evacuees has been inputted; the device being provided at an evacuation site and being capable of carried away from an evacuation site by an evacuee.
(2) In the evacuation notification terminal device according to (1), the evacuation notification information comprises a number of priority evacuees inputted using the numerical keys.
(3) An evacuation notification system according to the present invention comprises: an evacuation notification terminal device that is provided in an evacuation site, can be carried away from an evacuation site by an evacuee, and is capable of automatically wirelessly transmitting evacuation notification information including a number of evacuees inputted by an evacuee, an evacuation position automatically determined using a global positioning system (GPS) when the device is powered on, and identifying information for the evacuation notification terminal device at a predetermined time interval after the number of evacuees has been inputted; and a receiving terminal device that is provided in an evacuation monitoring location, is capable of displaying an evacuation position marker on a map displayed on a terminal screen and displaying a number of evacuees in association with the evacuation position marker on the basis of the number of evacuees, the evacuation position, and the identifying information included in the received evacuation notification information wirelessly transmitted from the evacuation notification terminal device, and is capable of displaying a history of the movement of the evacuation notification terminal device.

### Advantageous Effects of the Invention

As described above, the evacuation notification system according to the present invention comprises an evacuation notification terminal device provided in an evacuation site or the like and a receiving terminal device provided in an evacuation monitoring location, and the receiving terminal device displays an evacuation position marker on a map displayed on a terminal screen and displays a number of evacuees in association with the evacuation position marker on the basis of a number of evacuees, an evacuation position, and identifying information for the evacuation notification terminal device contained in evacuation notification information transmitted from the evacuation notification terminal device at a predetermined time interval, and displays a history of the movement of the evacuation notification terminal device, allowing an evacuation monitoring location such as a disaster center set up by local authorities to accurately ascertain evacuation locations and the number of individuals having evacuated thereto even during wire-ranging disasters and even when ordinary communication networks have been cut off. It is thus possible to accurately and swiftly ascertain evacuation conditions, allowing evacuee rescue/support efforts to be quickly organized.

The evacuation notification terminal device according to the present invention features a simple arrangement comprising input means, position-determining means, and transmission means. The evacuation notification terminal device is operated by an evacuee having evacuated to the evacuation site, and the evacuee simply uses the input means to input the number of evacuees. Simultaneously with this input operation, the position of the evacuation notification terminal device is automatically determined by the position-determining means, and evacuation notification information including the inputted number of evacuees, the determined evacuation position, and identifying information for the evacuation notification terminal device is created and automatically transmitted at a predetermined time interval. It is thus possible to transmit evacuation notification information via a simply operation. Moreover, even if an evacuee carries the evacuation notification terminal device to another evacuation site, the new position thereof is automatically determined, and evacuation notification information including the new number of evacuees and position information is created and transmitted at a predetermined time interval, allowing a disaster center to easily and accurately ascertain the new evacuation conditions. If the evacuation notification terminal device is provided in an emergency evacuation shelter or the like, similar effects are yielded if the emergency evacuation shelter itself is carried away.

The receiving terminal device according to the present invention receives a plurality of sets of evacuation notification information including at least a number of evacuees and an evacuation position transmitted from the evacuation notification terminal device, displays an evacuation position marker on a map displayed on a terminal screen of the receiving terminal device and displays a number of evacuees in association with the evacuation position marker on the basis of the number of evacuees and evacuation position included in the evacuation notification information, and displays the movement history of the evacuation notification terminal device if the device has moved, allowing for easy and accurate visual ascertainment of evacuation conditions over a broad geographical range and enabling the rapid organization of evacuee rescue/support efforts.

The present invention configured as described above allows an evacuation monitoring location (disaster center) to be notified of the number of individuals having evacuated to an evacuation site when a disaster such as a tsunami or flood occurs or when an evacuation warning is issued, allowing evacuation conditions to be rapidly and precisely ascertained in terms of the number and current position of evacuees and the safety of the evacuees to be ensured. The evacuation notification terminal device according to the present invention can also be provided in a lifeboat or the like provided in a ship or the like, allowing a rescue center or the like to rapidly and precisely ascertain evacuation conditions if a shipwreck occurs and enabling rescue efforts to be rapidly organized.

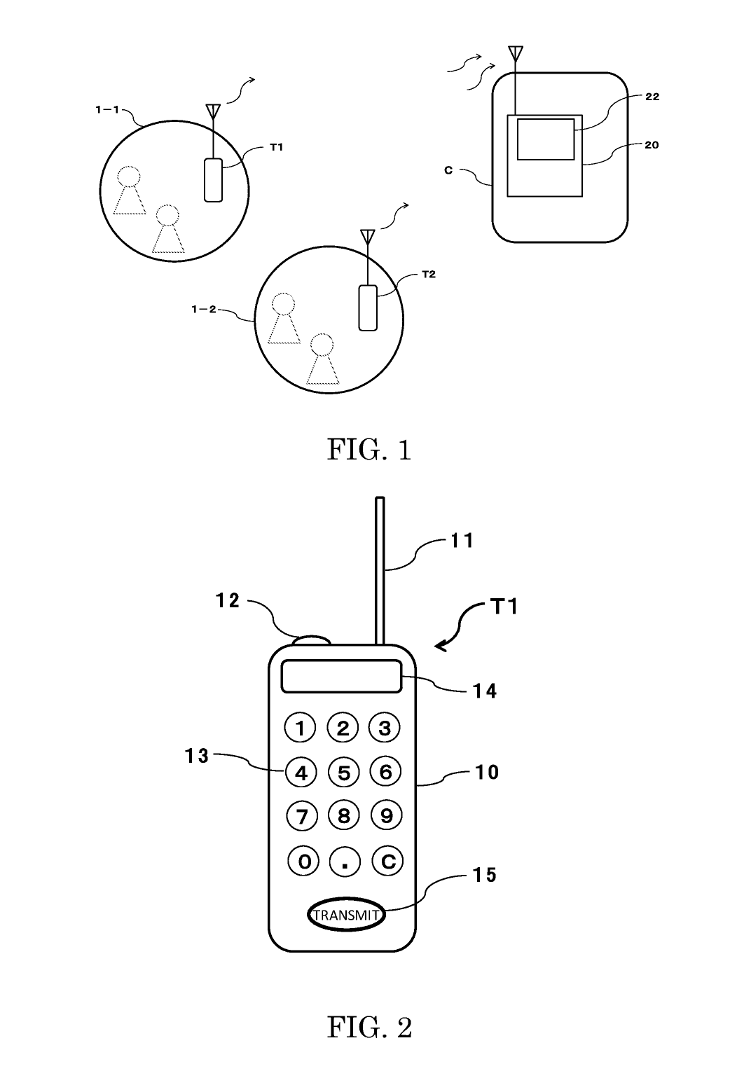

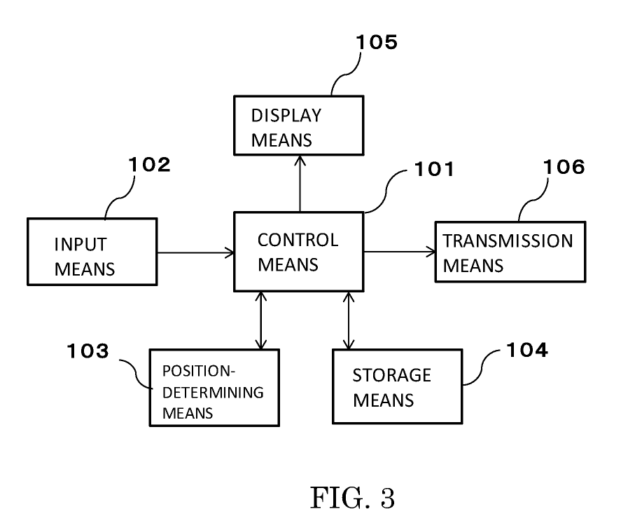

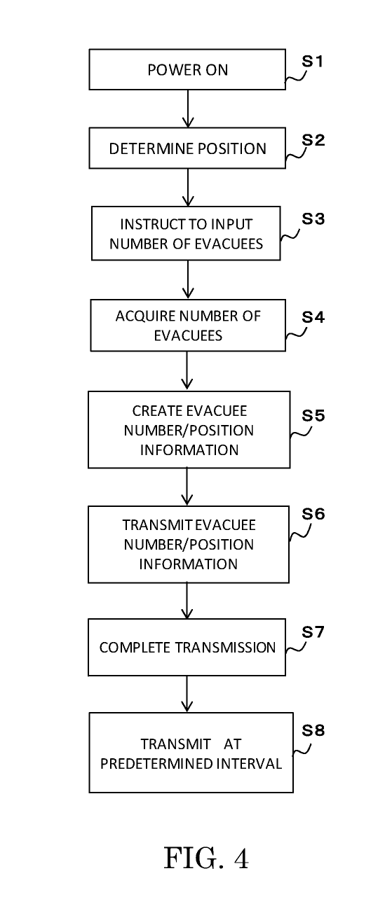

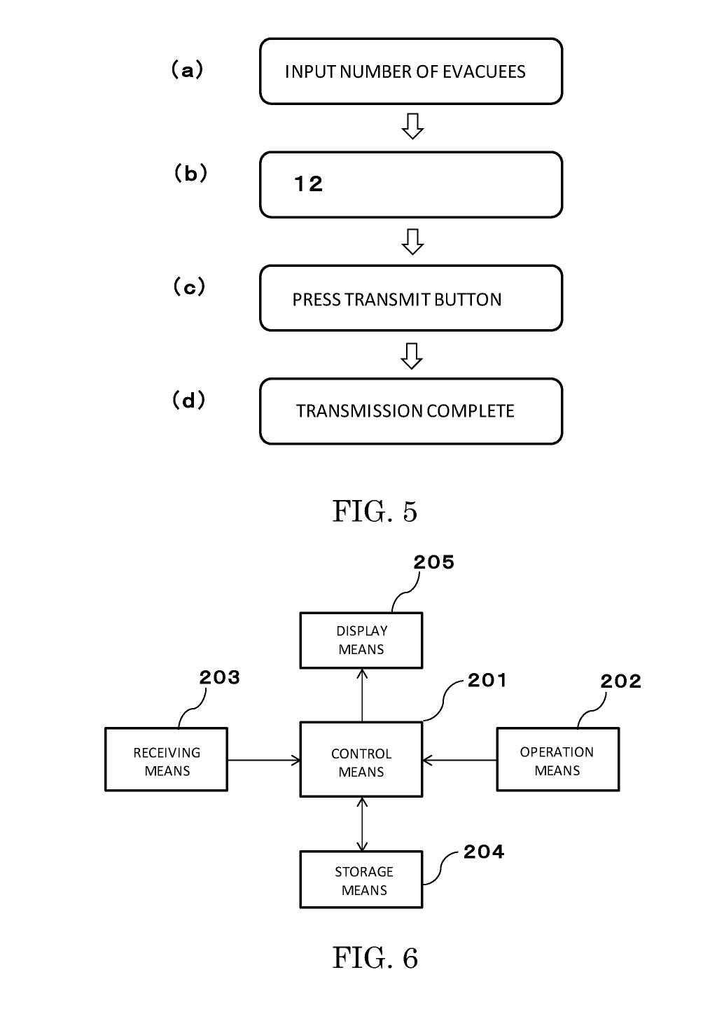

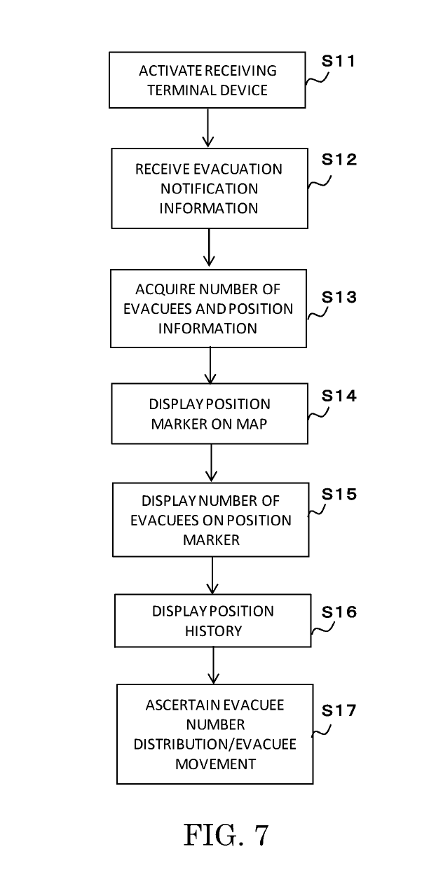

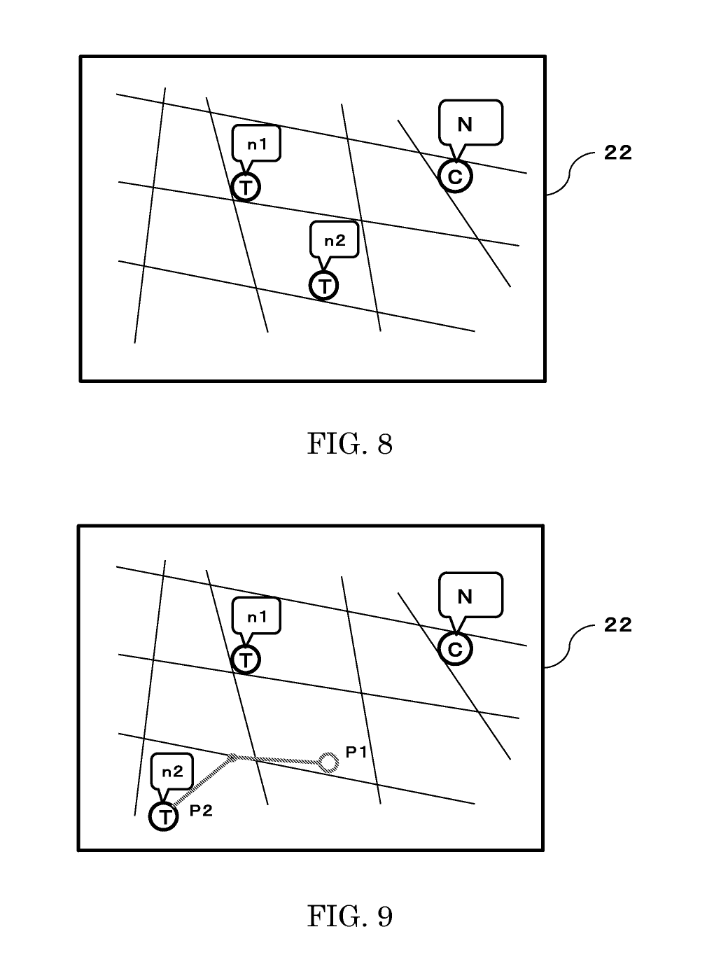

### BRIEF DESCRIPTION OF THE DRAWINGS

[FIG. 1] An overall schematic illustration of an evacuation notification system according to the present invention.

[FIG. 2] A schematic view of an evacuation notification terminal device according to the present invention.

[FIG. 3] An illustration of the system configuration of the evacuation notification terminal device according to the present invention.

[FIG. 4] An illustration of a process flow chart for the evacuation notification terminal device according to the present invention.

[FIG. 5] An illustration of a display process performed by the evacuation notification terminal device according to the present invention.

[FIG. 6] An illustration of the system configuration of a receiving terminal device according to the present invention.

[FIG. 7] An illustration of a process flow chart for the receiving terminal device according to the present invention.

[FIG. 8] An illustration of an example of a screen displayed by the receiving terminal device according to the present invention.

[FIG. 9] An illustration of an example of a screen displaying the movement history of the evacuation notification terminal device.

### DESCRIPTION OF THE EMBODIMENTS

An embodiment of the evacuation notification system according to the present invention will now be described via specific examples with reference to FIGS. 1-9.

FIG. 1 shows an overall schematic view of an example of the evacuation notification system according to the present invention. As shown in FIG. 1, an evacuation notification system comprises evacuation notification terminal devices T1, T2 provided at evacuation sites 1-1, 1-2 such as an emergency evacuation apparatus, an emergency evacuation apparatus such as an emergency evacuation shelter, a designated evacuation facility (school, civic hall, etc.), or a designated evacuation location, and a receiving terminal device 20 provided at a disaster center C serving as an evacuation monitoring location. FIG. 1 shows typical examples of evacuation sites; in actuality, more evacuation sites will be present. An evacuation notification terminal device T is provided at each evacuation site. The receiving terminal device 20 is capable of receiving evacuation notification information transmitted from each evacuation notification terminal device T. In this transmission system, wireless communication is preferably established between the evacuation notification terminal device and the receiving terminal device at least during emergency evacuation. In FIG. 1, evacuees are shown at the evacuation sites.

FIG. 2 shows a specific example of the evacuation notification terminal devices T1, T2 provided at the evacuation sites in the evacuation notification system shown in FIG. 1. FIG. 2 shows the evacuation notification terminal device T1 provided at evacuation site 1-1 as a typical example, but the evacuation notification terminal devices T provided at the other evacuation sites are configured similarly to T1. The evacuation notification terminal device T1 is provided with a terminal body 10, an antenna 11, a power button 12, input keys 13, a display screen 14, and a transmit button 15. The input keys 13 comprise numerical keys 0-9, a point key •, and a clear key C.

The terminal body 10 of the evacuation notification terminal device has a built-in battery acting as a power source, and terminal function is activated when an evacuee operates the power button 12. The battery is preferably normally charged by a solar power system. The evacuation notification terminal device is not fixed in place but can be carried around; in this case, terminal functioning is automatically activated when the evacuation notification terminal device is removed from a charger.

FIG. 3 shows a system configuration allowing for the terminal function of the evacuation notification terminal device. This system configuration is incorporated into the terminal body 10. The system configuration comprises control means 101, input means 102, position-determining means 103, storage means 104, display means 105, and transmission means 106. The input means 102 includes the input keys 13 and transmit button 15 with which the terminal body 10 is provided, and the position-determining means 103 determines the position of the evacuation notification terminal device using a global positioning system (GPS), thereby obtaining position information. At least identifying information for the evacuation notification terminal device, a terminal process program, and display messages are stored in the storage means 104. The display means 105 displays messages on the display screen 14 according to instructions from the control means 101.

FIG. 4 shows a process flow chart for the system configuration as described above. The flow chart follows a program stored in the storage means 104, and is executed by the control means 101. First, when the power is turned on either automatically or by an evacuee operating the power button 12 (step S1), the control means 101 instructs the position-determining means 103 to determine the position of the evacuation notification terminal device, obtains current position information, and stores the information in the storage means 104 (step S2). Next, the control means 101 loads the message “ENTER NUMBER OF EVACUEES” shown in FIG. 5 (a) from the storage means 104 and displays the message on the display screen 14 to instruct the user to input the number of evacuees (step S3).

Next, when an evacuee inputs the number of evacuees using the input keys 13, the control means 101 stores the number in the storage means 104, and, if the inputted number is, for example, twelve, displays “12” on the display screen 14 as shown in FIG. 5 (b) (step S4). At this point, the number of evacuees and position information for the evacuation notification terminal device have been obtained, so the control means 101 converts the identifying information for the evacuation notification terminal device, the evacuee number information, and the position information loaded from the storage means 104 to a format suitable for a transmission system to create evacuation notification information (step S5). Next, as shown in FIG. 5(c), the control means 101 displays the message “PRESS TRANSMIT BUTTON” on the display screen 14. After it has been confirmed that the evacuee has pressed the transmit button 15, the transmission means 106 is instructed to transmit the evacuation notification information (step S6), and the message “TRANSMISSION COMPLETE” is displayed on the display screen 14, as shown in FIG. 5 (c) (step S7). The control means 101 then uses a built-in timer function to automatically transmit the created evacuation notification information to the transmission means 106 at a predetermined time interval (such as one minute or five minutes) (step S8).

The clear key C of the input keys 13 can be used to correct the inputted number. An arrangement in which, if the evacuees taking shelter include injured individuals, elderly individuals, or other priority evacuees requiring priority response, the point key • of the input keys 13 can be pressed after the number of number of evacuees has been inputted to allow the number of priority evacuees to be inputted. For example, if there is one priority evacuee, the evacuee number information is “12•1”. Various messages are displayed on the display screen 14 in the various steps, but it is also possible to issue audio notifications instead of or in addition to displaying the messages. As the number of evacuees may change, if such a change occurs, the number of evacuees may be again inputted as long as the power is on; whenever this occurs, evacuation notification information including the evacuee number information, the position information determined at that time, and the identifying information can be transmitted by pressing the transmit button. In other words, evacuation notification information including an updated number of evacuees and current position can be transmitted. The evacuation notification information is automatically transmitted at a predetermined time interval. For the sake of the peace of mind of the evacuees, it is preferable that it be possible to transmit the presence of evacuees to the disaster center any number of times in realtime.

The foregoing has been a description of the evacuation notification terminal device of the evacuation notification system. An example of the receiving terminal device of the same system will now be described with reference to FIGS. 6-9.

FIG. 6 shows a system configuration allowing for the terminal functions of the receiving terminal device 20 provided in the disaster center C of the evacuation notification system shown in FIG. 1. The system configuration comprises control means 201, operation means 202, receiving means 203 comprising a receiving antenna, storage means 204, and display means 205. The operation means 202 is operated by a staff member of the disaster center C, and is used to control the functions of the evacuation notification terminal device. The receiving means 203 receives radio waves transmitted from the evacuation notification terminal device T to obtain evacuation notification information. At least map image information and location name information (including street numbers) association with positions on the map are stored in the storage means 204, as well as a terminal process program. The display means 205 displays at least a map image, a position marker, a number of evacuees, and movement history on the display screen 14 as instructed by the control means 101.

FIG. 7 shows a process flow chart for the system configuration as described above. The flow chart follows a program stored in the storage means 204, and is executed by the control means 201. First, a staff member of the disaster center C uses the operation means 202 to activate the receiving terminal device 20 when a disaster occurs or an emergency evacuation order is issued; alternatively, the device may always be activated in a reception-ready, i.e., standby state (step S11). When evacuation notification information is received via radio waves transmitted from the evacuation notification terminal device (step S12), the number of evacuees, position information, and identifying information is acquired from the evacuation notification information (step S13).

Next, the control means 201 loads the stored map image information from the storage means 204, sends the map information to the display means 205, and displays the display means 205 on a display screen 22. A position on the displayed map image is then identified on the basis of the acquired position information, and a position marker indicating the evacuation site, i.e., the current position of the evacuation notification terminal device, is displayed at that position (step S14). Any position marker is sufficient as long as the current position of the evacuation notification terminal device can be clearly displayed; a simple red dot or the like is acceptable. FIG. 8 shows Is surrounded by circles at two locations as one example. If multiple sets of evacuation notification information are received and acquired, position markers are displayed for all of the sets of evacuation notification information. If the map image shown on the display screen 22 is magnified, it is possible to clearly display, for example, the relationship between the current position of the evacuation notification terminal device and roads, as shown in FIG. 8. Displaying the disaster center C, for example, using a letter C surrounded by a circle, as shown in FIG. 8, allows the relative positions of the disaster center C and the evacuation site to be made clear.

The control means 201 then displays the number of evacuees associated with the displayed position marker on the basis of the evacuee number information obtained from the evacuation notification information (step S15). For example, callouts are displayed by the position marks indicating numbers of evacuees n1, n2, as shown in FIG. 8. Following the example shown in FIG. 5, the number (12) is displayed.

If the position information included in the received evacuation notification information is identical to position information included in previously received evacuation notification information, the number of evacuees may be overwritten and the displayed number of evacuees updated. If the evacuee number information includes priority information for injured individuals, elderly individuals, or the like, the callouts may display the number in, for example, red characters. Location information corresponding to the position may also be loaded from the storage means 204, and the place name or street number displayed in the callouts.

A total number N of evacuees can be displayed in callout extending from the position marker for the disaster center C on the basis of the evacuee number information acquired from all the sets of evacuation notification information. A staff member in the disaster center can also operate the operation means 202 to switch the screen shown on the display screen 22 or open a separate window within the displayed screen to display a list of current position place names (street numbers) and numbers of evacuees for each evacuation notification terminal device. At this stage, the disaster center serving as the evacuation monitoring location is also capable of swiftly and precisely ascertaining evacuation conditions at evacuation sites when a disaster such as a tsunami or flood occurs, or when an evacuation warning is issued.

The foregoing has been a description of a scenario in which an evacuation notification terminal device provided at an evacuation site stays at the evacuation site, and does not move. However, as discussed above, an evacuee may travel in search of a safer evacuation site if he or she decides that the current evacuation site is unsafe in view of the state of the disaster. In such cases, if the evacuation notification terminal device provided at the evacuation site can be carried while traveling, a position marker for the new position thereof is displayed on the display screen 22 in the disaster center C, and the callout displays the new number of evacuees. This allows the disaster center C to ascertain evacuation conditions in realtime.

In this case, an evacuee can use the evacuation notification terminal device that has been brought along to input a new number of evacuees after traveling and transmit the evacuation notification information. The receiving terminal device 20 at the disaster center C judges whether previously acquired identifying information and newly acquired identifying information are identical on the basis of the identifying information and the position information contained in the evacuation notification information received at the predetermined time interval, and, if the previously acquired identifying information is identical to the newly acquired identifying information, judges that the evacuation notification terminal device has moved if the previously acquired position information and the newly acquired position information differ, displays a position marker corresponding to the new current position and a new number of evacuees on the display screen 22 according to the newly acquired position information and evacuee number information, and displays movement history using a bold solid line extending from the previously acquired position, as shown in FIG. 9 (step S16). In the movement history display example shown in FIG. 9, a movement history indicating movement from a position P1 to a position P2 is shown. Black dots are used to show that the information has been received at a predetermined time interval, and displayed data based on previously acquired evacuation notification information is erased. An evacuation notification terminal device that has not moved (displaying the number of evacuees n1 in the callout in FIG. 9) can be indicated, for example, by causing the displayed position marker to flash at a predetermined time interval. In this way, a disaster center serving as an evacuation monitoring location can quickly and precisely ascertain evacuation conditions at evacuation sites when a disaster such as a tsunami or a flood occurs or when an evacuation warning is issued, allowing rescue/support efforts to ensure evacuee safety to be organized swiftly and appropriately (step S17).

In accordance with the emergency evacuation apparatus according to the aforementioned patent, upon the onset of a tsunami or flood, the ring-shaped floating body floats up and down along the guide means and does not drift away when the water level is lower than an expected water level, and the provided evacuation notification terminal device does not move, with the result that the position marker indicating current position does not move on the display screen of the receiving terminal device in the disaster center C. By contrast, if the water level exceeds expectations, the ring-shaped floating body is separated from the guide means and drifts away. However, even in this case, the evacuation notification terminal device provided in the ring-shaped floating body moves as the ring-shaped floating body drifts along, the evacuees taking shelter in the ring-shaped floating body can input new numbers of evacuees and repeatedly transmit evacuation notification information, and evacuation notification information is automatically transmitted at predetermined time intervals. Thus, a display process similar to that performed when the evacuation notification terminal device moves due to being carried is performed on the display screen of the receiving terminal device in the disaster center C, allowing the drifting to be ascertained in realtime.

Furthermore, by providing the evacuation notification terminal device in a lifeboat or life raft on a ship or the like, a rescue center or the like can quickly and precisely ascertain evacuee number information for evacuees in the lifeboat and position information for the lifeboat in a manner similar to when the terminal is provided in an emergency evacuation shelter if, for example, a shipwreck occurs. The drifting of the boat can also be ascertained in realtime.

### REFERENCE SIGNS LIST

10 Terminal body
11 Antenna
12 Power button
13 Input key
14, 22 Display screen
15 Transmit button
20 Receiving terminal device
101, 201 Control means
102 Input means
104, 204 Storage means
105, 205 Display means
106 Transmission means
202 Operation means
203 Receiving means
C Disaster center
T1, T2 Evacuation notification terminal device

1. An evacuation notification terminal device comprising:
input means comprising at least numerical keys for inputting a number of evacuees having evacuated to an evacuation site;
position-determining means that uses a global positioning system (GPS) to automatically determine evacuation position when the device is powered on;
control means for creating evacuation notification information including the inputted number of evacuees, the determined evacuation position, and identifying information for the evacuation notification terminal device; and
transmission means for automatically wirelessly transmitting the created evacuation notification information at a predetermined time interval when a transmit button is pressed after the number of evacuees has been inputted by an evacuee;
the device being provided at an evacuation site and being capable of being carried away from the evacuation site by an evacuee.

2. The evacuation notification terminal device according to claim 1, wherein the evacuation notification information comprises a number of priority evacuees inputted using the numerical keys.

3. An evacuation notification system comprising:
an evacuation notification terminal device that is provided in an evacuation site, can be carried away from an evacuation site by an evacuee, and is capable of automatically wirelessly transmitting evacuation notification information including a number of evacuees inputted by an evacuee, an evacuation position automatically determined using a global positioning system (GPS) when the device is powered on, and identifying information for the evacuation notification terminal device at a predetermined time interval after the number of evacuees has been inputted; and
a receiving terminal device that is provided in an evacuation monitoring location, is capable of displaying an evacuation position marker on a map displayed on a terminal screen and displaying a number of evacuees in association with the evacuation position marker on the basis of the number of evacuees, the evacuation position, and the identifying information included in the received evacuation notification information wirelessly transmitted from the evacuation notification terminal device, and is capable of displaying a history of the movement of the evacuation notification terminal device.
